(19) United States
(12) Patent Application Publication
(10) Pub. No.: US 2026/0238573 A1
(43) Pub. Date: Aug. 13, 2026

(54) TRANSMITTING DELAY INFORMATION FOR EXTENDED REALITY (XR)

(71) Applicant: Google LLC, Mountain View, CA (US)

(72) Inventor: Shiangrung Ye, Taipai City (TW)

(21) Appl. No.: 19/155,912

(22) PCT Filed: Feb. 14, 2024
(86) PCT No.: PCT/US2024/015722

§ 371 Date: Aug. 12, 2025

Related U.S. Application Data
(60) Provisional application No. 63/485,384, filed on Feb. 16, 2023.
(60) Provisional application No. 63/446,293, filed on Feb. 16, 2023.
(60) Provisional application No. 63/542,688, filed on Oct. 5, 2023.

(51) Int. Cl. H04L 43/0852; H04L 69/322

(52) U.S. Cl. CPC H04L 43/0852; H04L 69/322

(57) ABSTRACT

Methods and systems provide for transmitting (312) delay information for extended reality (XR) communications. The data packets include a protocol data unit (PDU) set. The delay information includes remaining time periods for transmitting data packets from a user equipment (UE) to a network entity and a type of the PDU set. The UE and the network entity mutually understand a reference time related to the delay information. The network entity and the UE use an agreed-upon reference time to determine the value of delay information (e.g., remaining time or queueing delay) for the data packets. In one example, the reference time pertains to the UE receiving an uplink grant from the network entity. In another example, the reference time pertains to when the UE transmits the delay information. The delay information further includes a PDU set importance (PSI) for the type of the PDU set.

### CROSS-REFERENCE TO RELATED APPLICATIONS

This application claims the benefit of and priority to U.S. Provisional Application Ser. No. 63/485,384, entitled “TRANSMITTING DELAY INFORMATION FOR EXTENDED REALITY (XR),” filed on Feb. 16, 2023, U.S. Provisional Application Ser. No. 63/446,293, entitled “TRANSMITTING DELAY INFORMATION FOR EXTENDED REALITY (XR),” filed on Feb. 16, 2023, and U.S. Provisional Application Ser. No. 63/542,688, entitled “TRANSMITTING DELAY INFORMATION FOR EXTENDED REALITY (XR),” filed on Oct. 5, 2023, the disclosures of which are incorporated herein by reference in their entirety.

### FIELD

The present disclosure relates generally to wireless communication, and more particularly, to extended reality (XR) communications.

### BACKGROUND

The Third Generation Partnership Project (3GPP) is currently in the process of specifying a new Radio Interface called 5G New Radio (5G NR) as well as a Next Generation Packet Core Network (NG-CN or NGC). The 5G NR architecture will have three components: a 5G Radio Access Network (5G-RAN), a 5G Core Network (5GC), and a User Equipment (UE). In order to facilitate the enablement of different data services and requirements, the 3GPP 5G NR cellular network supports network slicing, which enables the multiplexing of virtualized and independent logical networks on the same physical network infrastructure.

Extended reality (XR) includes various augmented reality, virtual reality, and mixed reality applications that take advantages of 5G NR network capabilities (e.g., latency, data transfer rate, etc.). The XR services are characterized by stringent requirements for periodicity, multiple flows, jitter avoidance, low latency, high reliability, among others. Due to high frame rate requirements for XR applications, the XR traffic may suffer from jitter due to the variations in delay when video frames are encoded. The XR packet size is also variable. In some cases, a codec segments the packets into protocol data unit (PDU) sets, which are of different types and sizes. Therefore, XR traffic poses a specific set of challenges in view of the XR traffic characteristics. For example, a base station often does not know the delay of uplink data packets in one or more UEs and may not correspondingly manage (e.g., prioritize) the one or more UEs.

### SUMMARY

The present disclosure provides methods and techniques for transmitting delay information for extended reality (XR) communications. In aspects, the delay information includes remaining time periods for transmitting data packets from a user equipment (UE) to a network entity. A remaining time period represents the time available until a packet's delivery deadline. If a transmitter fails to transmit a packet before its delivery deadline, the transmitter will discard the packet (and not transmit the packet) and the network will experience packet loss. And if a receiver receives the packet after the delivery deadline, the receiver will discard the received packet and network will experience packet discard. In practice, because different data packets have different delays, the network entity may treat the data packets differently (e.g., by prioritizing some packets over other packets). Thus, providing the delay information to the network entity allows for informed network management, such as managing the data packets over different channels (e.g., logical channels or radio bearers) as well as managing multiple UEs.

The disclosed methods and techniques may apply to the 5th generation (5G) new radio (NR) network systems and beyond (e.g., 6G). For illustrative purposes, 5G systems are used as example embodiments herein. At a high level, the present disclosure provides various techniques to convert traffic parameters (e.g., non-radio or general packet radio service (GPRS) tunneling protocol (GTP) parameters), from application servers to the core network, into radio signaling parameters from the RAN to UEs in order to indicate application characteristics without causing negative impact, and perhaps substantially improving on, data transfer rate, latency, or other aspects (e.g., by supporting improved settings at the RAN and the UEs).

XR may include augmented reality (AR), virtual reality (VR), and mixed reality (MR). VR immerses users in a virtual environment substituting perceptions of actual surroundings (e.g., the wearer of VR gears is not expected to sense the actual surroundings). AR provides a computer-generated overlay to the actual surroundings with clear indication of the virtual overlay (e.g., floating graphics, markers, numbers, or texts on top of objects in the actual surroundings). MR provides a realistic artificial overlay (e.g., computer-generated items as part of the actual surrounding perception). As such, XR requires instant and large quantities of data exchange between UEs and XR service providers.

As mentioned previously, XR services are characterized by stringent requirements for periodicity, multiple flows, jitter avoidance, low latency, high reliability, among others. For example, cloud gaming (CG) often uses remote servers to execute gaming applications, thus requiring instant (e.g., real time or near real time) streaming of visual contents, user controls, and feedback to the user. Additionally, XR traffic may be quasi-periodic inverse to the frame rate.

In XR communications, the delay information of a packet may support XR communications in 5G. For example, the delay information may include at least the remaining time of transmitting the packet to a delivery deadline (e.g., configured or requested by the network entity). According to aspects of this disclosure, the UE reports the delay information to the network entity so that the network entity may use the delay information for network management including uplink resource scheduling. As such, the present disclosure provides example methods and techniques for reporting data packet delay information so that the network entity may improve network management for XR communications.

For example, the present disclosure provides implementations of a reference time for the UE and the network entity to mutually understand the delay information. The network entity and the UE may use an agreed-upon reference time to determine the value of delay information (e.g., remaining time or queueing delay) for data packets. Without the reference time, the network entity may not accurately, or may not be able to, ascertain the remaining time for a data packet to arrive. In a first embodiment, the reference time pertains to the UE receiving an uplink grant from the network entity. In a second embodiment, the reference time pertains to when the UE transmits the delay information (e.g., in an uplink transmission according to an uplink grant). In a third embodiment, the reference time pertains to when the UE transmits the uplink data.

In addition, the present disclosure provides methods and techniques for selectively transmitting a subset of the delay information of an amount of data packets in the UE's buffer. That is, the UE will not report all delay information of all data packets in the UE's buffer, as this may cause unnecessarily large signaling overhead. Rather, the present disclosure uses timing thresholds to filter out the delay information associated with data packets that may be discarded (e.g., packet loss or packet discard) and prioritize the delay information associated with data packets that may be urgent (e.g., in view of certain delivery deadlines). In some cases, the delay information includes the remaining time period to a deadline for PDU sets, types of PDU sets, and/or the PDU set importance (PSI) information, for prioritizing the delay information.

According to aspects of the present disclosure, for example, a UE estimates, during communications with a network entity, a time period for completing a transmission of an amount of data in a buffer prior to a delivery deadline for that amount of data. The amount of data may be the full buffer contents or only a subset of the buffer contents. The UE identifies, based on the delivery deadline, delay information associated with the amount of data in the buffer. The UE transmits the delay information to the network entity in response to an uplink grant received from the network entity. For example, during operation, the UE receives from the network entity a first message configuring the UE with one or more channels and the parameters associated with the channel(s). The UE then generates and transmits to the network entity a second message containing delay information in accordance to a reference time or the associated parameters.

According to aspects of the present disclosure, a network entity transmits, to a UE, a configuration that indicates one or more channels and associated parameters for an uplink transmission. The network entity receives delay information from the UE regarding the uplink transmission. The delay information is associated with a time period for completing, before a delivery deadline, a transmission of an amount of data in a buffer of the UE. The network transmits, to the UE, an uplink grant based on the delay information and computes a delivery deadline using the time period and a reference time agreed upon between the UE and the network entity. Knowing the delaying information, the network entity may manage the UE (and other UEs) by updating uplink transmission configurations that address packet delays and/or prioritizations to complete packet deliveries prior to delivery deadlines for those packets.

Details of XP delay information transmission, and various aspects of the present disclosure are discussed in detail below.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a diagram of a wireless communications system that includes a plurality of user equipments (UEs) and network entities in communication over one or more cells, in accordance with aspects of this disclosure.

FIG. 2 illustrates an example protocol stack according to which a UE communicates with a network entity, in accordance with some aspects of the present disclosure.

FIG. 3 is a signaling diagram illustrating communications between a UE and a network entity for transmitting delay information, in accordance with some aspects of the present disclosure.

FIG. 4 is a flow diagram illustrating an example method performed by the UE in wireless communication system, in accordance with aspects of this disclosure.

FIG. 5 is a diagram illustrating an example of determining remaining time of data using different reference times, in accordance with aspects of this disclosure.

FIG. 6 is a diagram illustrating an example of determining which remaining time to transmit to the network entity, in accordance with aspects of this disclosure.

FIG. 7 is a diagram illustrating examples of messages including delay information to the network entity, in accordance with aspects of this disclosure.

FIG. 8 is a flow diagram illustrating an example method performed by the network entity.

FIG. 9 is a flowchart of a method of wireless communication at a UE, in accordance with aspects of this disclosure.

FIG. 10 is a flowchart of a method of wireless communication at a network entity, in accordance with aspects of this disclosure.

FIG. 11 is a diagram illustrating a hardware implementation for an example UE apparatus, in accordance with aspects of this disclosure.

FIG. 12 is a diagram illustrating a hardware implementation for one or more example network entities, in accordance with aspects of this disclosure.

FIGS. 13A-13D illustrate examples of one or more messages that an example UE uses to transmit delay information and data volume information, in accordance with aspects of this disclosure.

Like numerals indicate like elements.

### DETAILED DESCRIPTION

For ease of illustration, the following techniques are described in an example context in which one or more UEs and RANs implement one or more radio access technologies (RATs) including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, the present disclosure is not limited to networks employing a 5G NR RAT configuration, but rather the techniques described herein can be applied to any combination of different RATs employed at the UEs and the RANs. Also, the present disclosure is not limited to the examples and context described herein, but rather the techniques described herein can be applied to any network environment.

The present disclosure provides methods and techniques for transmitting delay information for extended reality (XR) communications. In aspects, the delay information includes remaining time periods for transmitting data packets from a user equipment (UE) to a network entity. A remaining time period represents the time available until a packet's delivery deadline. If a transmitter fails to transmit a packet before its delivery deadline, the transmitter will discard the packet (and not transmit the packet) and the network will experience packet loss. And if a receiver receives the packet after the delivery deadline, the receiver will discard the received packet and network will experience packet discard. In practice, because different data packets experience different delays, the network entity may treat the data packets differently (e.g., by prioritizing some packets over other packets). Thus, providing the delay information to the network entity allows for informed network management, such as managing the data packets over different channels (e.g., logical channels or radio bearers) as well as managing multiple UEs.

XR may refer to human-machine interaction experiences with visual, audio, and/or haptic computer-generated object enhancement or replacement. For example, XR may be one or more of augmented reality (AR), mixed reality (MR), virtual reality (VR), and interpolations among these XR variations. AR refers to providing a user with additional information or artificial generated items or content overlaid upon the real surroundings. VR refers to a rendered version (e.g., generated by computers) of a visual/audio scene. MR refers to an advanced form of AR where some virtual elements are inserted into the physical scene with the intent to provide the illusion that the elements are part of the real scene. In some cases, AR, MR, and VR may generally be referred to as immersion, which often requires measurements of motions of the user (e.g., six degrees of freedom) and providing near-instant feedback (e.g., via visual, audio, and tactile components) to the user. Computer technologies (e.g., 3D graphics and measurements) and wearable technologies (e.g., motion sensors, visual and audio feedback, etc.) are enablers of XR. For example, human-to-machine and human-to-human communications take advantages of handheld and wearable end user devices (e.g., UEs). These technologies capture, generate, process, and communicate with a large amount of data, often in real time (or with stringent low latency requirement).

A UE software application queues data in a transmit buffer for transmission to a network entity. The data may be organized into PDU sets. A PDU set includes one or more PDUs carrying a payload of one unit of information generated at the application level (e.g., a video frame or video slice). A PDU set containing multi-modal data may be called a multi-modal PDU set. A multi-modal PDU set refers to a PDU set including different data types (e.g., video data and audio data and pose data, etc.) that are closely related and require application coordination for a multi-modal application (e.g., an XR application). Multi-modal data is defined to describe the input data from different kinds of user experience components/sensors or the output data to different kinds of destinations (e.g., one or more UEs) required for the same task or application. Multi-modal data may include more than one stream of single-modal data (e.g., left channel and right channel).

Single-modal data can be seen as one type of data. A PDU set may be a single modal PDU set. A single modal PDU set refers to a PDU set including single-modal data of the same data type (e.g., only video data, only audio data, only haptic data, only pose data, etc.) associated with the same application (e.g., XR application). For both types of PDU sets, multi-modal or single-modal, the PDUs of a PDU set are transmitted within the same quality of service (QOS) flow. The PDU sets may be classified according to a PDU set importance (PSI) which identifies the relative importance/priority of a PDU set compared to other PDU sets within a QoS flow. The PSI of a multi-modal PDU set may depend on the PSIs of the single-modal PDUs (or PDU sets) contained within the multi-modal PDU set. A radio access network (RAN) may use PSI for instructing PDU set packet discarding in presence of network congestion. A PDU set Information and Identification (dynamic information for downlink (DL) provided by user plane in general packet radio system tunnelling protocol user plane (GTP-U) header) includes PDU set Sequence Number, PDU set Size in bytes, PDU sequence number (SN) within a PDU set, and/or an indication of End PDU of the PDU set.

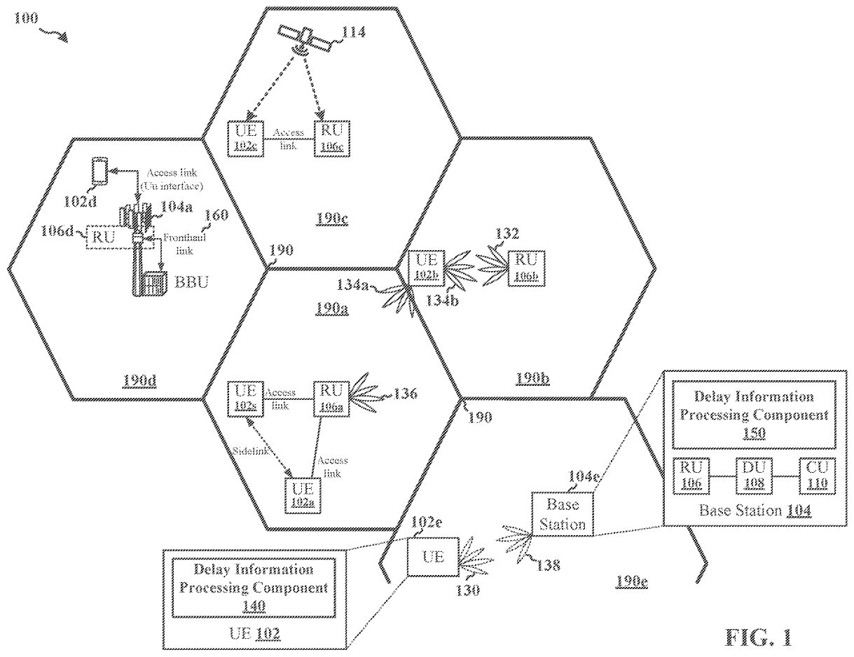

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the network entity(ies) 104a/104e and/or the RUs 106a-106d may communicate with the UEs 102a-102d and 102s via one or more radio frequency (RF) access links based on a Uu interface. In examples, multiple RUs 106 and/or network entity(ies) 104 may simultaneously serve the UEs 102, such as by intra-cell and/or inter-cell access links between the UEs 102 and the RUs 106/network entity(ies) 104.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other network entity(ies) 104 or one or more other disaggregated base station units via the wired or wireless transmission medium. In examples, a processor, a memory, and/or a controller associated with executable instructions for the interfaces can be configured to provide communication between the network entity(ies) 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The network entity(ies) 104 provide the UEs 102 with access to a core network. The network entity(ies) 104 might relay communications between the UEs 102 and the core network. The network entity(ies) 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the network entity(ies) 104/RUs 106 may be based on multiple-input and multiple-output (MIMO) antenna technology, including spatial multiplexing, beamforming, and/or transmit diversity. The communication links may be associated with one or more carriers. The UEs 102 and the network entity(ies) 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHZ-52.6 GHZ) and FR2-2 (52.6 GHz-71.0 GHz). Although a portion of FR1 is actually greater than 6 GHZ, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHZ, FR4, which ranges from 71.0 GHz-114.25 GHZ, and FR5, which ranges from 114.25 GHZ-300 GHz. The upper limit of FR5 corresponds to the upper limit of the EHF band. Thus, unless otherwise specifically stated herein, the term “sub-6 GHZ” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the network entity(ies) 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the network entity(ies) 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more network entity(ies) 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a delay information processing component 140 configured to estimate, during communications with a network entity, a time period for completing a transmission of an amount of data in a buffer of the UE to the network entity. The delay information processing component 140 may ascertain a delivery deadline based on the time period and a reference time agreed upon between the UE and the network entity. The delay information processing component 140 identifies, based on the delivery deadline, delay information associated with the amount of data in the buffer. The UE 102 transmits the delay information to the network entity 104 in response to an uplink grant received from the network entity.

In certain aspects, any of the network entity(ies) 104 or a base station of the network entity(ies) 104 may include a delay information processing component 150 configured to transmit, to the UE 102, a configuration that indicates one or more channels and associated parameters for an uplink transmission. The network entity 104 receives delay information from the UE regarding the uplink transmission, the delay information associated with a time period for completing a transmission of an amount of data in a buffer of the UE 102. The network entity 104 then transmits, to the UE, an uplink grant based on the delay information and a delivery deadline computed using the time period and a reference time agreed upon between the UE and the network entity.

As shown in FIG. 1, the diagram 100 illustrates an example system architecture of a 5G system capable of delivering data for extended reality (XR) applications (e.g., XR traffic). In FIG. 1, relevant functions of the 5G system are illustrated, including the UE 102, the RAN node (CU 110), and the core network (CN). The CN includes the user plane function (UPF), the trusted data network (DN), the policy control function (PCF), and the network exposure function (NEF). XR specific functions or components may include the 5G-XR client of the UE 102, the application function (AF) and the application server (AS) in the trusted DN, as well as the AF and AS in the external DN, which provides various XR applications. The external DN may be a 5G-XR application provider leveraging 5G system functionalities (e.g., coupled with the NEF and UPF of the 5G system). The UE 102 including a 5G-XR aware application may make use of the 5G-XR client and network functions, using network interfaces and APIs. The 5G-XR application and the 5G-XR client of the UEs 102 may capture and communicate user data to the RAN.

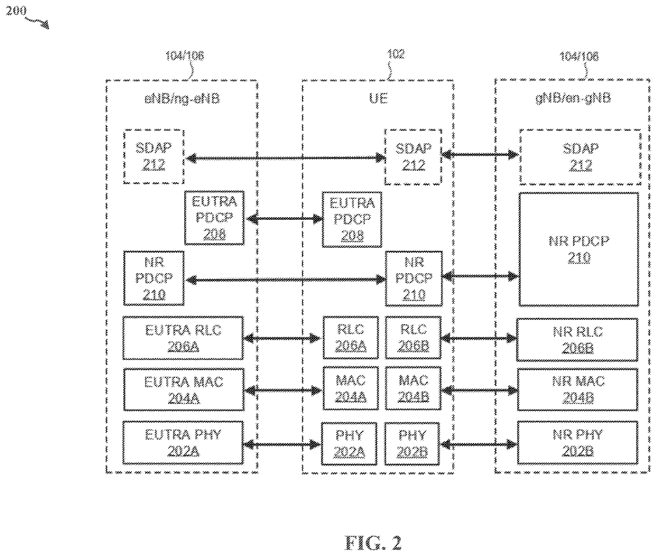

FIG. 2 illustrates an example protocol stack 200 according to which the UE 102 can communicate with an eNB/ng-eNB or a gNB (e.g., one or both of the network entity(ies) 104a and 104e). In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210.

Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” For example, when a UE software application queues data in a transmit buffer for transmission to a network entity, the data may be organized into PDU sets. A PDU set includes one or more PDUs carrying a payload of one unit of information generated at the application level (e.g., a video frame or video slice).

In some implementations, the application layer needs the PDUs in a PDU Set to use the corresponding unit of information. In other implementations, the application layer can still recover parts or all of the information unit, when some PDUs are missing.

A PDU set containing multi-modal data may be called a multi-modal PDU set. A multi-modal PDU set refers to a PDU set including different data types (e.g., video data and audio data and pose data, etc.) that are closely related and require application coordination for a multi-modal application (e.g., an XR application). Multi-modal data is defined to describe the input data from different kinds of devices/sensors or the output data to different kinds of destinations (e.g., one or more UEs) required for the same task or application. Multi-modal data may include more than one single-modal data.

Single-modal data can be seen as one type of data. A PDU set may be a single modal PDU set. A single modal PDU set refers to a PDU set including single-modal data of the same data type (e.g., only video data, only audio data, only haptic data, only pose data, etc.) associated with the same application (e.g., XR application).

For both types of PDU sets, multi-modal or single-modal, the PDUs of a PDU set are transmitted within the same quality of service (QoS) flow. The PDU sets may be classified according to a PDU set importance (PSI) which identifies the relative importance/priority of a PDU set compared to other PDU sets within a QoS flow. The PSI of a multi-modal PDU set may depend on the PSIs of the single-modal PDUs (or PDU sets) contained within the multi-modal PDU set. For example, the PSI of a multi-modal PDU set may be equivalent to the highest priority PSI of any contained single-modal PDU. As another example, a PSI of a multi-modal PDU set may be a different value than any of the PSIs of the contained single-modal PDUs. A radio access network (RAN) may use PSI for PDU set packet discarding in presence of network congestion. A PDU set Information and Identification (dynamic information for downlink (DL) provided by user plane in general packet radio system tunnelling protocol user plane (GTP-U) header) includes PDU set Sequence Number, PDU set Size in bytes, PDU sequence number (SN) within a PDU set, and/or an indication of End PDU of the PDU set.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

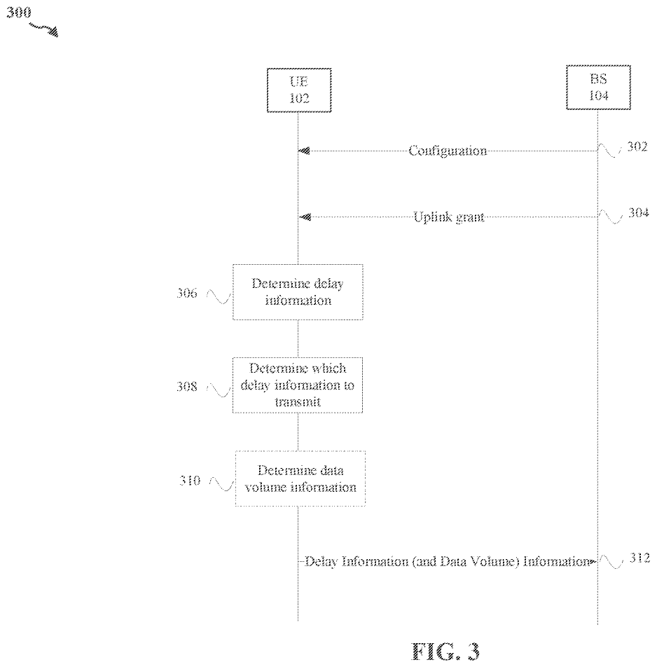

FIG. 3 is a signaling diagram 300 illustrating communications between a UE 102 and a network entity (e.g., the BS 104) for transmitting delay information, in accordance with some aspects of the present disclosure. As shown, the BS 104 transmits 302 a configuration to the UE 102. The configuration may indicate one or more channels and associated parameters for an uplink transmission. The BS 104 then transmits 304 an uplink grant to the UE 102.

When the UE 102 receives the uplink grant, the UE 102 determines 306 delay information (e.g., a remaining time to delivery deadline or queueing delay for a corresponding packet or set of packets) for the data stored in its buffer. In some cases, the data stored in the buffer include one or more protocol data unit (PDU) sets. The delay information further includes a type of the PDU set (e.g., for prioritizing the delay information when multiple types of PDU sets are present). The delay information may include a PDU set importance (PSI) for the type of the PDU set.

The UE 102 determines 308 which delay information (corresponding to which data packet or set of packets, or PDU sets) is to be transmitted to the BS 104. Optionally, the UE 102 determines 310 the data volume (e.g., buffer size) that should be transmitted to the BS 104. The UE 102 may determine the delay information and/or the data volume based on the type of PDU set of the PDU sets. In some cases, the BS 104 may indicate a PSI threshold to the UE 102. The UE 102 compares the PSI to the threshold to determine whether or when to discard or transmit the PDU sets, or determine the time period needed for transmitting the PDU sets.

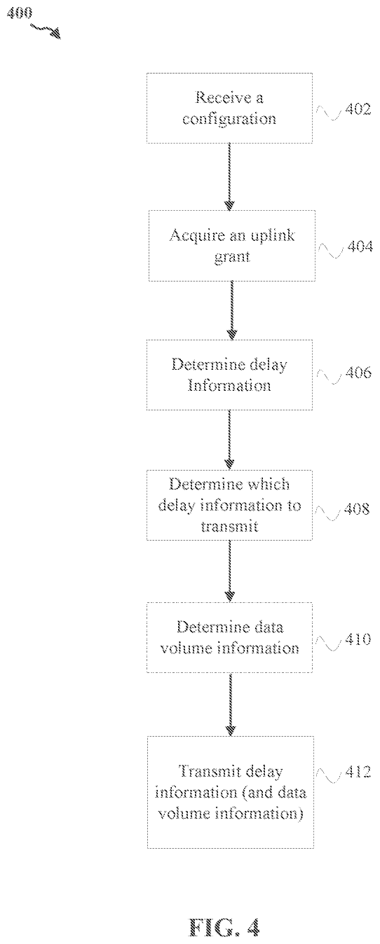

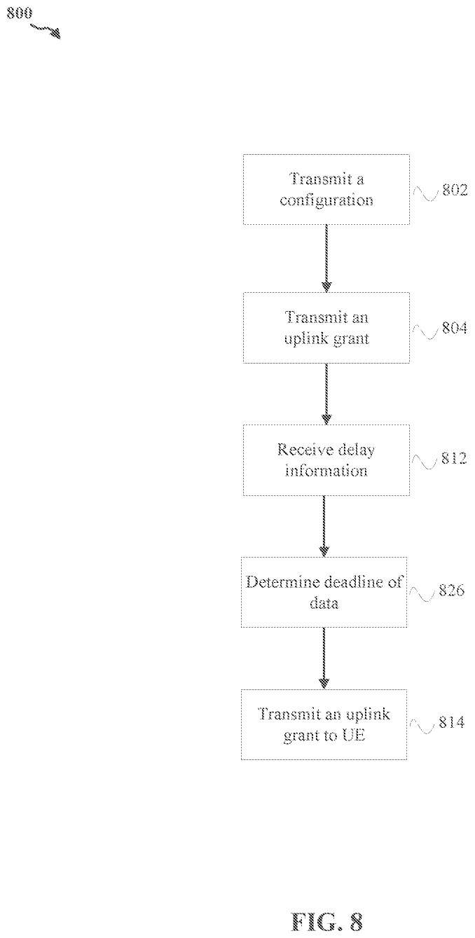

Based on the determinations, the UE 102 transmits 312 delay information (and optionally data volume information) to the BS 104. Detailed operations are further discussed in relation to FIGS. 4 and 8.

FIG. 4 is a flow diagram 400 illustrating an example method performed by the UE in wireless communication system in accordance to the present disclosure. The UE 102 of FIGS. 1 and 3 may perform the example method shown in the flow diagram 400. As shown, the UE receives 402 a configuration from a network entity. The UE acquires 404 an uplink grant, which may provide information for the UE to determine 406 delay information for the data in the UE's buffer. The UE determines 408 which delay information of the data packets to transmit to the network entity. In some cases, the UE optionally determines 410 data volume information. The UE transmits 412 delay information (and optional data volume information) to the network entity. Detail examples of the operations are discussed below.

At 402, UE 102 receives a first message containing configuration from the network entity (e.g., the BS 104). In an embodiment, the configuration 302 includes at least one of: a delay budget for a channel (or channel group), data from the channel (channel group) having the same delay budget, an offset to a reference time, a max number of delay information to transmit for a channel (or channel group), a first threshold for selecting delay information to transmit for a channel (or channel group), or a second threshold for selecting delay information to transmit for a channel (or channel group). In some cases, the first threshold is used to determine what or whether data are urgent to report (e.g., the UE 102 transmitting urgent PDU in remaining time), and the second threshold is used to prevent reporting of urgent data whose delivery deadline will be due.

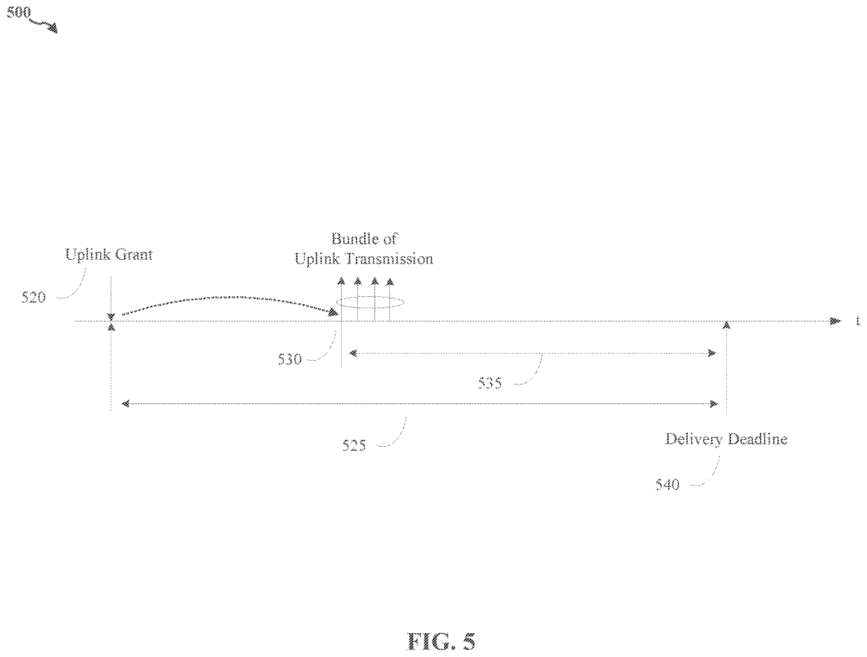

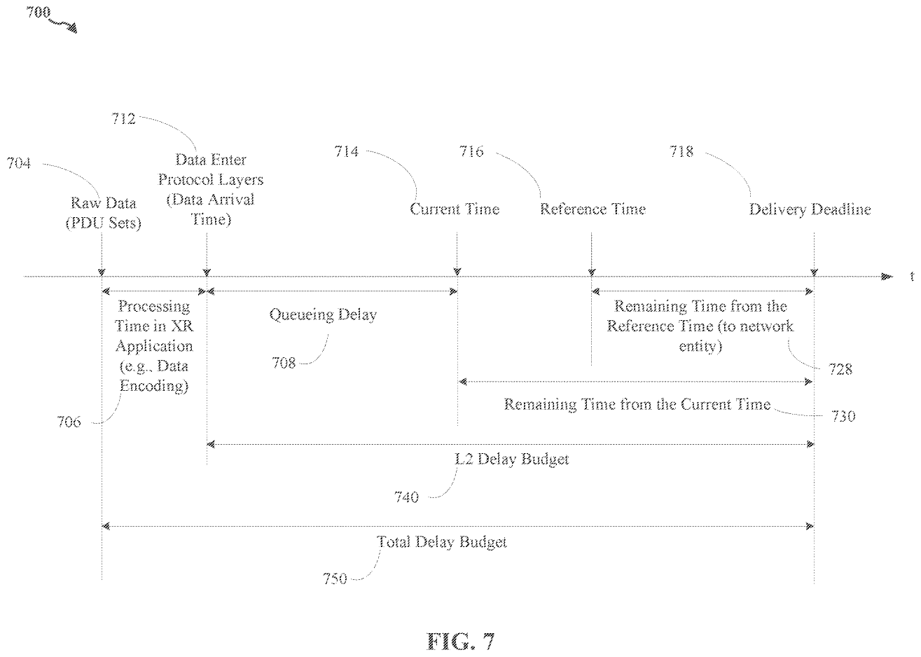

For example, the channel may be a logical channel or a radio bearer. The delay budget (such as the total delay budget, see FIG. 7) provides for a definition of the delivery deadline. In other words, the raw data generated in the application of the UE need be transmitted to the network entity by the delivery deadline. The delay information pertains to a remaining time (e.g., an expectation of delivery) associated with the transmission of the delay information. These parameters are to be agreed by both the UE and the network entity (as discussed in FIG. 5).

In some cases, not all delay information for all data packets in the buffer of the UE may be worth informing the network entity (because some data packets may be lost or discarded). The first threshold and the second threshold allow the UE to determine (see 406 and 408) to not transmitting delay information for some of the data packets.

At 404, UE acquires an uplink grant from BS. In one example, the UE acquires an uplink grant by receiving a downlink control information (DCI) on PDCCH from BS (see, e.g., TS 38.322). In another example, the UE acquires an uplink grant in a random access response (RAR) message in random access procedure (see, e.g., TS 38.321). In another example, the UE acquires an uplink grant from its memory. The UE stores an uplink grant in memory and uses the uplink grant with a periodicity configured by the network entity. In some embodiments, the UE acquires an uplink grant in a RRCReconfiguraiton or RRCRelease message from the network entity.

At block 406, UE 102 determines the value of delay information for data, stored in buffer, in accordance to a reference time and a delivery deadline. The present disclosure provides options for defining a reference time at various points of time during the signaling between the UE and the network entity. For example, in one embodiment, the UE 102 uses the time that the UE 102 receives an uplink grant as the reference time to determine the delay information (e.g., FIG. 5 element 520).

The data stored in the buffer might include various types of PDU sets of different sizes. The delay information includes a type of a PDU set such as single-modal or multi-modal (e.g., for prioritizing the delay information when multiple types of PDU sets are present) as well as PSI for that PDU set type. The UE may compare the PSI to a threshold to determine whether or when to discard or transmit the PDU set(s), or determine the time period needed for transmitting the PDU set(s). For example, the UE calculates the time for transmission based on the size of the PDU set, the type of the PDU set, as well as the priority (i.e., PSI) of the PDU set. The UE may use the PSI and/or the delivery deadline to discard PDU sets that may not be delivered (e.g., low priority and/or insufficient delay budget).

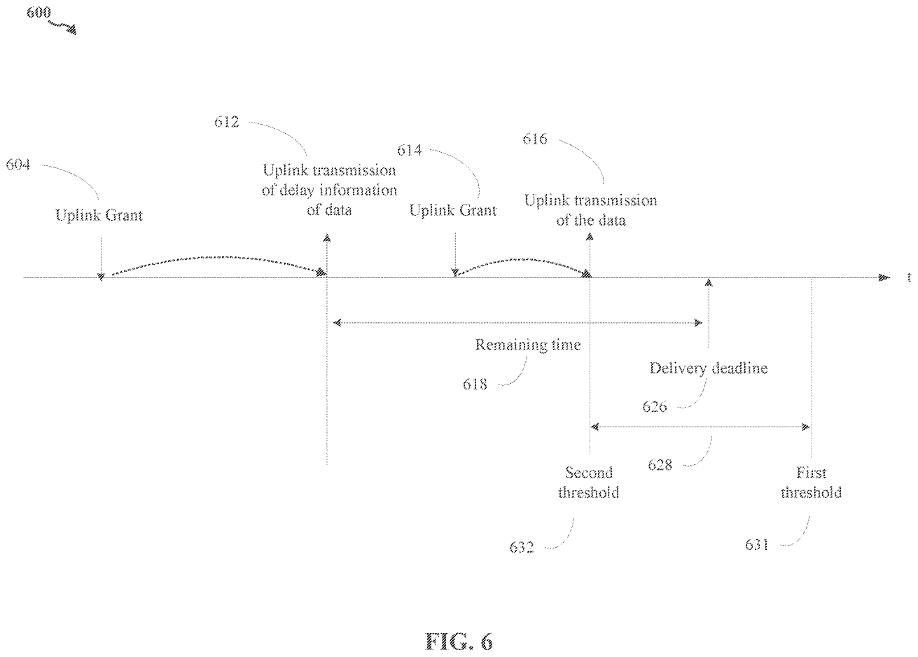

In another embodiment, UE 102 uses the time that UE 102 will transmit delay information as reference time to determine the delay information (e.g., 530 of FIG. 5). In either embodiment (reference time as FIG. 5 element 520 or FIG. 6 element 612), if the configuration 302 from the network entity includes an offset, UE applies the offset value to the reference time. For example, the reference time is adjusted by the offset (e.g., adding or subtracting the offset).

In some cases, if the uplink grant schedules a bundle of uplink transmissions, UE 102 uses one of the uplink transmissions in the bundle as reference time (e.g., at a time at or after 530 of FIG. 5 or FIG. 6 element 616, amongst the bundle of uplink transmissions). For example, UE uses the first (or another) transmission in the bundle as a reference time. In one example, in the bundle, the first uplink transmission is an initial uplink transmission. The rest of the transmissions in the bundle are repetitions of the initial uplink transmission. In another example, UE may transmit one of the uplink transmissions in a bundle.

In some embodiments related to the delay information, the delay information may be defined as the remaining time to the delivery deadline of data (see the remaining time at the reference time in FIG. 7). For example, the remaining time is the difference between the delivery deadline and the reference time. Here, as mentioned earlier, the UE may ascertain the delivery deadline based on the data arrival time (e.g., when the data enters the protocol layers) and the delay budget (e.g., L2 delay budget shown in FIG. 7). That is, the delivery deadline is relatively certain when the data has entered the protocol layers and equals to the sum of the data arrival time and the delay budget (e.g., the L2 delay budget in FIG. 7).

In another embodiment, the delay information is the queueing delay of data (e.g., the time period after entering the protocol layers, see FIG. 7). For example, the queueing delay may equal to a difference between the reference time (or the current time) and the data arrival time (the time entering the protocol layers). In some embodiments, the reference time may be measured in or include one or more OFDM symbols, slots, subframes, etc.

At 408, the UE 102 determines which delay information to transmit to the network entity. As the above discussed delay information applies to each data packet or packet set, the UE needs not transmit all delay information for all packets, because not all data may arrive in time. The UE may therefore select some remaining time periods (over others) as the delay information for transmission.

In one example, if the remaining time of data (e.g., one or more data packets) is shorter than or equal to the first threshold, the UE selects the remaining time to transmit as delay information. Similarly, if the delivery deadline of the data is due before the reference time plus the first threshold, the UE selects the remaining time to transmit (because the remaining time may be helpful for the network to determine priority and thus manage multiple UEs based on the priority). An example of the first threshold is illustrated as 631 in FIG. 6. In some cases, the network entity may indicate the first threshold in the configuration message sent 302 to the UE 102. In some cases, the first threshold is a predefined value (e.g., 20 ms).

In an example, if remaining time is larger than or equal to a second threshold, the UE selects the remaining time to transmit as delay information. Similarly, if the delivery deadline of data occurs after the reference time plus the second threshold, the UE selects the remaining time to transmit as delay information (because the remaining time indicates that the UE has sufficient time to transmit the corresponding data and thus the delay information is useful). An example of the second threshold is illustrated as 632 in FIG. 6. In some cases, the network entity may include the second threshold in configuration message sent 302 to the UE 102. In some cases, the second threshold is a predefined value. In some embodiments, the second threshold is a time between when the UE transmits delay information of the data and when the UE transmits the data.

In one example related to queueing delay selection, when the queueing delay of data is less than or equal to a third threshold (not shown), the UE 102 selects the queueing delay to transmit. For example, the third threshold may be a filter to cut-off data expecting to have a long buffer delay. In one embodiment, the network entity includes the third threshold in the configuration message sent 302 to the UE 102. In another embodiment, the third threshold is a predefined (e.g., constant, default, or preconfigured) value.

In one example, if queueing delay of data is larger than or equal to a fourth threshold, the UE 102 selects the queueing delay to transmit. For example, the fourth threshold may be used to indicate data that have been delayed the most (and thus the most needed for transmission). Similar to the embodiments above, the network entity may include the fourth threshold in the configuration message sent 302 to the UE 102. In another embodiment, the third threshold is a predefined (e.g., constant, default, or preconfigured) value. In some embodiments, the fourth threshold is the time period between the time when the UE transmits the delay information of the data and the time when the UE transmits the data.

In some embodiments related to overhead reduction, for a channel (or a channel group), there may have more than one remaining time periods (or queueing delays) selected for transmission to the network entity. In one embodiment, the UE may transmit the shortest remaining time among the selected remaining times (or longest queueing delays) to the network entity. In another embodiment, the UE may transmit the first N (a number of) shortest remaining time among the selected remaining times (or N longest queueing delays). The number N may be included in the configuration message sent 302 from the network entity to the UE.

At 410, the UE 102 optionally determines the value of data volume to transmit to the network entity. The delay information selected at 408 is referred to as “selected delay information” herein, referring to either qualified remaining time(s) as well as qualified queueing delay(s) to be transmitted to the network entity.

In one embodiment, UE computes the data volume for a PDU set. The data volume is the sum of sizes of the data, whose delay information is selected to transmit, in the PDU set. Data in the same PDU set has the same delay budget and the same deadline.

In another embodiment, UE computes the data volume for a channel. The data volume is the sum of sizes of the data, from the channel, whose delay information is selected to transmit.

In another embodiment, UE computes the data volume for a channel group. The data volume is the sum of sizes of the data, from the channel group, whose delay information is selected to transmit.

At 412, UE 102 generates and transmit the delay information (e.g., via a message, such as a second message in view of the configuration message being the first message) to include the delay information (and data volume information) determined above.

In one embodiment, the second message includes a bitmap field. Each bit in the bitmap is associated with a channel (or channel group). The bit is used to indicate the presence of delay information field(s) of the channel (or the channel group). For example, If the UE includes delay information(s) of a channel (or channel group) in the second message, the UE sets the bit, which is mapped to the channel (or channel group), to a first value (e.g., 1). If the UE does not include delay information(s) of the channel (or channel group) in the message, the UE sets the bit to a second value (e.g., 0).

In another embodiment, the UE includes an identifier field in the second message. The UE sets the identifier field to the identifier of a channel (or channel group). An identifier field is associated with delay information field(s) in the second message. The UE sets the delay information fields to the delay information of the channel.

To include multiple delay information for a channel (or channel group) in the second message, each delay information is associated with an extension field. The extension field indicates whether the delay information is the last delay information of the channel (or channel group) in the second message.

In one embodiment, the UE places the extension field immediately after its associated delay information. The extension field is one bit. If the field is set to a first value, it means its associated delay information is the last one delay information.

In one embodiment, if The UE includes delay information of a channel (or a channel group) in the second message, the UE also includes data volume information in the second message. The data volume information is placed after the delay information. In one embodiment, the second message is an MAC control element, defined in 3GPP 38.321. In some cases, UE sets the delay information field to the value of the delay information. In some cases, UE sets the delay information field to an indicator which is associated with a range of time that the delay information falls within.

FIG. 5 is a diagram 500 illustrating an example of determining remaining time of data using different reference times 520, 530. As shown, the UE may receive an uplink grant from the network entity at the time instant 520. The UE may transmit, according to the uplink grant, an uplink transmission at the time instant 530.

In one embodiment, UE determines the remaining time 525 relative to the delivery deadline 540 in accordance to the time that UE acquires an uplink grant (e.g., based on the reference time 520). In another embodiment, UE determines the remaining time 535 according to the time when the UE transmits at the time instant 530.

In some cases, the uplink grant schedules a bundle of uplink transmissions. UE uses one of the uplink transmissions (e.g., the first uplink transmission-corresponding to the time instant 530) as the reference time to determine the remaining time of data (e.g., the first one transmission).

FIG. 6 is a diagram 600 illustrating an example of determining a remaining time to be used in the delay information for informing the network entity. In the illustrated example, the UE receives two uplink grants from the network entity, the first uplink grant 604, and the second uplink grant 614. For example, the first uplink grant 604 may indicate to the UE when to transmit the delay information, which includes the remaining time 618 until the delivery deadline 626 as anchored on the time of transmission 612 of the delay information.

As discussed above, the UE may use different reference times (e.g., the UE receiving the first uplink grant as shown in FIG. 5 elements 520 and 525, the UE transmitting the uplink user-plane (UP) data as shown in FIG. 5 elements 530 and 535, or the UE transmitting the delay information as shown in FIG. 6 elements 612 and 618). Here, the UE uses the uplink transmission time instant 612 as the reference time. That is, the reference time 612 is the time that UE transmits the delay information reflecting the remaining time 618 until the delivery deadline 626. As such, the remaining time 618 is measured from the uplink transmission time instant 612 to the delivery deadline 626. During operation, the UE may receive the second uplink grant 614, which indicates to the UE an uplink transmission 616 configuration for the uplink user-plane data.

After the UE transmits 612 the delay information, the network entity transmits the second uplink grant 614 to the UE. The UE may transmit the delay information based on the second uplink grant 614, which may provide information regarding the first threshold 631 and the second threshold 632, as discussed in various embodiments above. For example, the first threshold 631 is determined based on a time period 628 measured from the uplink transmission 616 time instant according to the second uplink grant 614, while the second threshold 632 is determined as the same time instant with the uplink transmission 616. In some cases, the first threshold 631 is used to determine what or whether urgent data is to report, such as which PDU is urgent so the UE transmits the PDU within the remaining time.

The second threshold 632 is the time between that UE transmits 612 the delay information of data and that UE transmits 616 the data of the delay information. If the deadline of data is due during this time (e.g., before the second threshold 632), UE will not transmit its delay information for this data because UE will discard the data. The first threshold 631 is a warning line that data may reach its delivery deadline soon and thus risk packet discard at the receiver. In some cases, the second threshold 632 enables the UE to determine which PDU whose delivery deadline will be due before a second grant (e.g., the second uplink grant 614) is provided.

FIG. 7 is a diagram 700 illustrating examples of timing determination and messages including delay information to the network entity. As shown, the UE may generate raw data including PDU sets at the time instant 704. The duration between the raw data generation at 704 and the delivery deadline 718 is the total delay budget 750.

The duration between the raw data generation at 704 and the time instant 712 when the data enter protocol layers is the processing time 706 in the XR application of the UE (e.g., when the UE performs data encoding). The time instant 712 when the data enter the protocol layers may also be referred to as the data arrival time.

After the data has entered the protocol layers, the current time 714 is measured based on the queueing delay 708 (from the data arrival time, i.e., the time instant 712). That is, the UE determines aspects of reporting the delay information based on the current time, or how much a queueing delay 708 is since the data arrival.

The time period between the current time 714 and the delivery deadline 718 is the remaining time 730 from the current time 714, which should be within the L2 delay budget 740 (measured between the data arrival time 712 and the delivery deadline 718).

The time period between the reference time 716 and the delivery deadline 718 is the remaining time 728 from the reference time 716. The reference time 716 may be similar to the reference times 520, 530, or 612 of FIGS. 5 and 6. The UE may report either the remaining time 728, the remaining time 730, or both, to the network entity as the delay information.

In some implementations, the processing time in the XR application (e.g., data encoding) and the total delay budget are measured from the time instant when the raw data are generated in the XR application. The queueing delay and the L2 delay budget are measured at the time instant when data enters the protocol layers, which correspond to the data arrival time in the present disclosure. The remaining time may be measured against the current time (e.g., the UE knows the current time and how much data remain to be transmitted), and may be measured against the reference time (e.g., as discussed in the examples above) as mutually understood by both the transmitter and the receiver. The delay information of the remaining time measured against the reference time may be useful to the network entity for UE and scheduling management to improve the changes of data delivery prior to the delivery deadline.

FIG. 8 is an example of a method 800, performed by the network entity, in accordance to the present disclosure. At 802, the network entity transmits a first message that contains configuration 302 to UE. In an example, the first message be a radio resource control (RRC) reconfiguration message. In another example, the first message is an RRC setup message. In another example, the first message may be an RRC re-establishment message or an RRC resume message (see, e.g., TS 38.321). In other examples, the first message is a system information message.

At 804, the network entity transmits an uplink grant to UE. The uplink grant indicates the time that UE should use the uplink grant to transmit delay information, the network entity uses the time UE transmits delay information as reference time to compute deadline of data in according to the delay information that the network entity receives from UE.

At 812, the network entity receives the delay information (and data volume information) from UE. At 826, the network entity determines the deadline of data from the received delay information. In one embodiment, deadline is (reference time+the remaining time). In another embodiment, the deadline is (reference time+delay budget−queueing delay).

At 814, the network entity transmits an uplink grant to UE with data whose deadline is first to due among UEs. the network entity allocates resources to the UE to transmit the amount of data that UE reports to the network entity in data volume information.

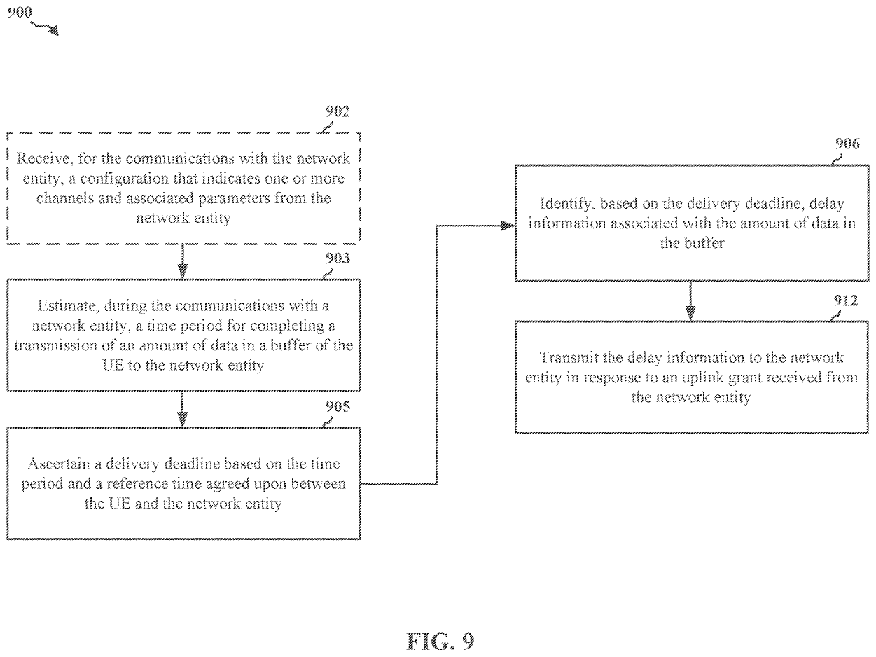

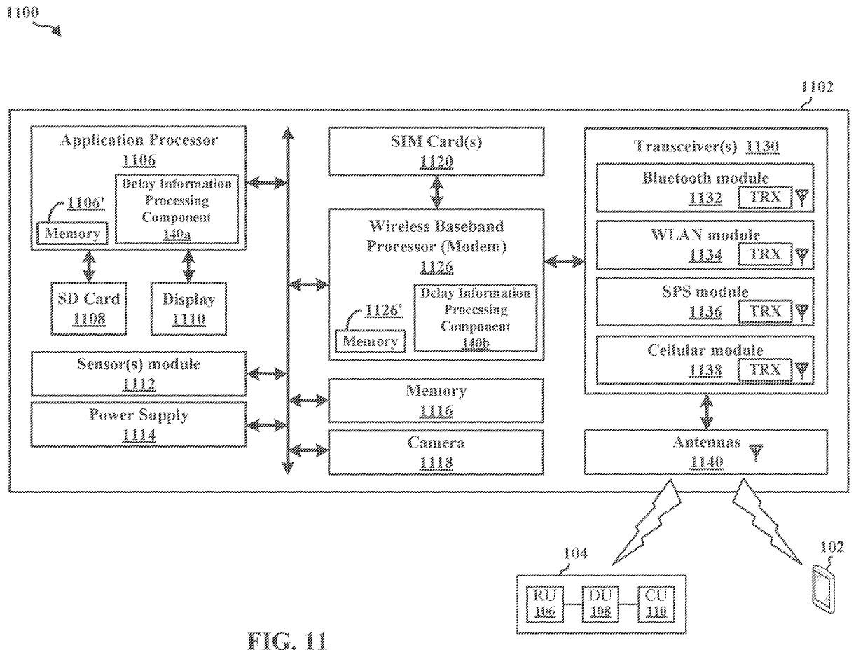

FIG. 9 illustrates a flowchart 900 of a method of wireless communication at a UE. With reference to FIGS. 1 and 11, the method may be performed by the UE 102, the UE apparatus 1102, etc., which may include the memory 1126′, 1106′, 1116, and which may correspond to the entire UE 102 or the entire UE apparatus 1102, or a component of the UE 102 or the UE apparatus 1102, such as the wireless baseband processor 1126 and/or the application processor 1106.

The UE receives 902 for communications with the network entity, a configuration that indicates one or more channels and associated parameters from the network entity.

The UE estimates 903, during the communications with a network entity, a time period for completing a transmission of an amount of data in a buffer of the UE to the network entity. For example, a UE software application queues the amount of data in the buffer for transmission. The data are organized as PDU sets, each of which includes one or more PDUs carrying a payload of one unit of information generated at the application level (e.g., a video frame or video slice).

The time period for completing the transmission of the PDU sets depends on the PDU set type (single-modal or multi-modal), PDU set size, and/or importance of the PDU sets, among other factors.

The UE ascertains 905 a delivery deadline based on the time period and a reference time agreed upon between the UE and the network entity.

The UE identifies 906, based on the delivery deadline, delay information associated with the amount of data in the buffer.

The UE transmits 912 the delay information to the network entity in response to an uplink grant received from the network entity.

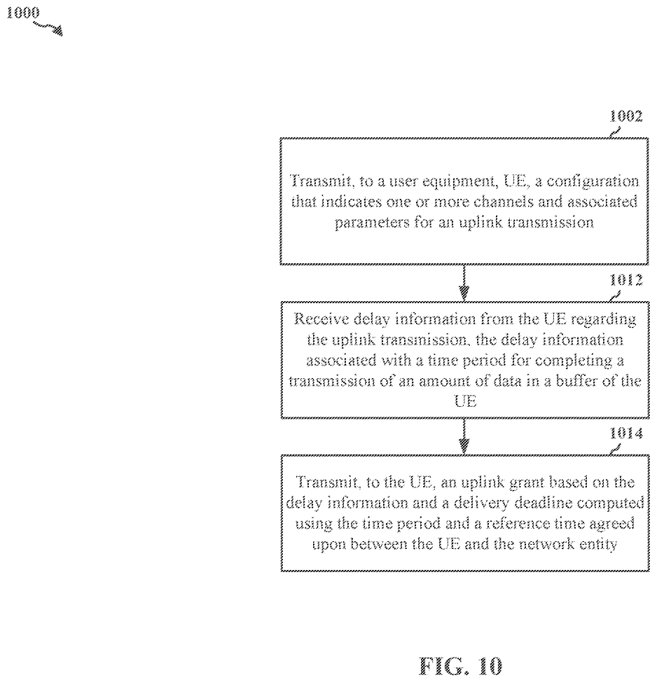

FIG. 9 describes a method from a UE-side of a wireless communication link, whereas FIG. 10 describes a method from a network-side of the wireless communication link, complementary to the method on the UE-side.

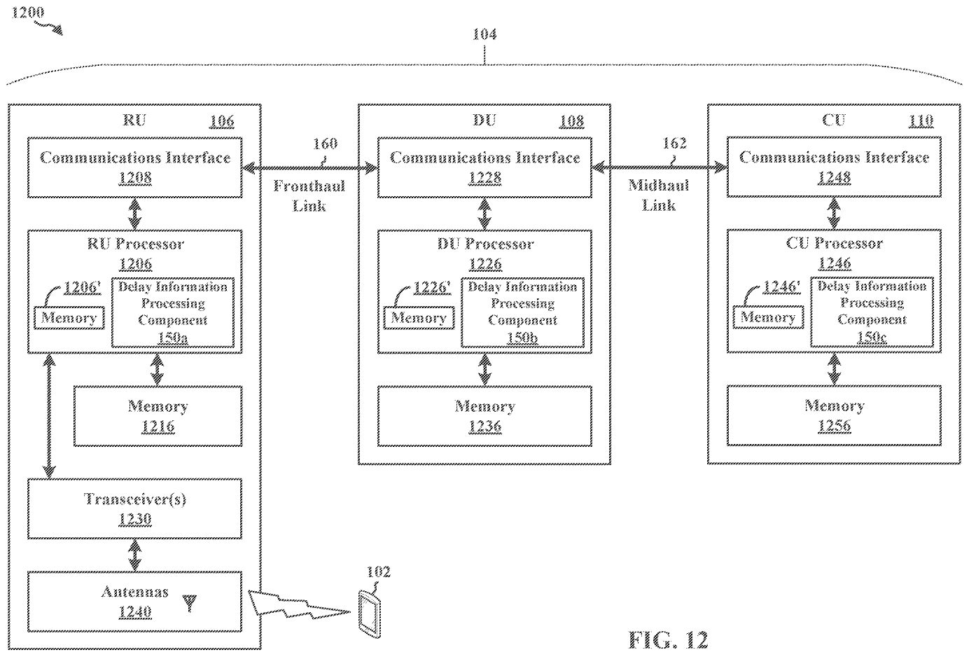

FIG. 10 is a flowchart 1000 of a method of wireless communication at a network entity. With reference to FIGS. 1 and 12, the method may be performed by one or more network entities 104, which may correspond to a base station or a unit of the base station, such as the RU 106, the DU 108, the CU 110, an RU processor 1206, a DU processor 1226, a CU processor 1246, etc. The one or more network entities 104 may include memory 1206′/1226′/1246′, which may correspond to an entirety of the one or more network entities 104, or a component of the one or more network entities 104, such as the RU processor 1206, the DU processor 1226, or the CU processor 1246.

The network entity transmits 1002, to the UE, a configuration that indicates one or more channels and associated parameters for an uplink transmission.

The network entity receives 1012 delay information from the UE regarding the uplink transmission, the delay information associated with a time period for completing, prior to a delivery deadline, a transmission of an amount of data in a buffer of the UE.

The network entity transmits 1014, to the UE, an uplink grant (e.g., 614 of FIG. 6) based on the delay information and a delivery deadline computed using the time period and a reference time agreed upon between the UE and the network entity.

A UE apparatus 1102, as described in FIG. 11, may perform the method of flowchart 900. The one or more network entities 104, as described in FIG. 12, may perform the method of flowchart 1000.

FIG. 11 is a diagram 1100 illustrating an example of a hardware implementation for a UE apparatus 1102. The UE apparatus 1102 may be the UE 102, a component of the UE 102, or may implement UE functionality. The UE apparatus 1102 may include an application processor 1106, which may have on-chip memory 1106′. In examples, the application processor 1106 may be coupled to a secure digital (SD) card 1108 and/or a display 1110. The application processor 1106 may also be coupled to a sensor(s) module 1112, a power supply 1114, an additional module of memory 1116, a camera 1118, and/or other related components. For example, the sensor(s) module 1112 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1102 may further include a wireless baseband processor 1126, which may be referred to as a modem. The wireless baseband processor 1126 may have on-chip memory 1126′. Along with, and similar to, the application processor 1106, the wireless baseband processor 1126 may also be coupled to the sensor(s) module 1112, the power supply 1114, the additional module of memory 1116, the camera 1118, and/or other related components. The wireless baseband processor 1126 may be additionally coupled to one or more subscriber identity module (SIM) card(s) 1120 and/or one or more transceivers 1130 (e.g., wireless RF transceivers).

Within the one or more transceivers 1130, the UE apparatus 1102 may include a Bluetooth module 1132, a WLAN module 1134, an SPS module 1136 (e.g., GNSS module), and/or a cellular module 1138. The Bluetooth module 1132, the WLAN module 1134, the SPS module 1136, and the cellular module 1138 may each include an on-chip transceiver (TRX), or in some cases, just a transmitter (TX) or just a receiver (RX). The Bluetooth module 1132, the WLAN module 1134, the SPS module 1136, and the cellular module 1138 may each include dedicated antennas and/or utilize antennas 1140 for communication with one or more other nodes. For example, the UE apparatus 1102 can communicate through the transceiver(s) 1130 via the antennas 1140 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1126 and the application processor 1106 may each include a computer-readable medium/memory 1126′, 1106′, respectively. The additional module of memory 1116 may also be considered a computer-readable medium/memory. Each computer-readable medium/memory 1126′, 1106′, 1116 may be non-transitory. The wireless baseband processor 1126 and the application processor 1106 may each be responsible for general processing, including execution of software stored on the computer-readable medium/memory 1126′, 1106′, 1116. The software, when executed by the wireless baseband processor 1126/application processor 1106, causes the wireless baseband processor 1126/application processor 1106 to perform the various functions described herein. The computer-readable medium/memory may also be used for storing data that is manipulated by the wireless baseband processor 1126/application processor 1106 when executing the software. The wireless baseband processor 1126/application processor 1106 may be a component of the UE 102. The UE apparatus 1102 may be a processor chip (e.g., modem and/or application) and include just the wireless baseband processor 1126 and/or the application processor 1106. In other examples, the UE apparatus 1102 may be the entire UE 102 and include the additional modules of the apparatus 1102.

The delay information processing component 140 may be within the application processor 1106 (e.g., at 140a), the wireless baseband processor 1126 (e.g., at 140b), or both the application processor 1106 and the wireless baseband processor 1126. The delay information processing component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 12 is a diagram 1200 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1246, which may have on-chip memory 1246′. In some aspects, the CU 110 may further include an additional module of memory 1256 and/or a communications interface 1248, both of which may be coupled to the CU processor 1246. The CU 110 can communicate with the DU 108 through a midhaul link 162, such as an F1 interface between the communications interface 1248 of the CU 110 and a communications interface 1228 of the DU 108.

The DU 108 may include a DU processor 1226, which may have on-chip memory 1226′. In some aspects, the DU 108 may further include an additional module of memory 1236 and/or the communications interface 1228, both of which may be coupled to the DU processor 1226. The DU 108 can communicate with the RU 106 through a fronthaul link 160 between the communications interface 1228 of the DU 108 and a communications interface 1208 of the RU 106.

The RU 106 may include an RU processor 1206, which may have on-chip memory 1206′. In some aspects, the RU 106 may further include an additional module of memory 1216, the communications interface 1208, and one or more transceivers 1230, all of which may be coupled to the RU processor 1206. The RU 106 may further include antennas 1240, which may be coupled to the one or more transceivers 1230, such that the RU 106 can communicate through the one or more transceivers 1230 via the antennas 1240 with the UE 102.

The on-chip memory 1206′, 1226′, 1246′ and the additional modules of memory 1216, 1236, 1256 may each be considered a computer-readable medium/memory. Each computer-readable medium/memory may be non-transitory. Each of the processors 1206, 1226, 1246 is responsible for general processing, including execution of software stored on the computer-readable medium/memory. The software, when executed by the corresponding processor(s) 1206, 1226, 1246 causes the processor(s) 1206, 1226, 1246 to perform the various functions described herein. The computer-readable medium/memory may also be used for storing data that is manipulated by the processor(s) 1206, 1226, 1246 when executing the software. In examples, the delay information processing component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

The delay information processing component 150 may be within one or more processors of the one or more network entities 104, such as the RU processor 1206 (e.g., at 150a), the DU processor 1226 (e.g., at 150b), and/or the CU processor 1246 (e.g., at 150c). The delay information processing component 150a-150c may be one or more hardware components specifically configured to carry out the stated processes/algorithm, implemented by one or more processors 1206, 1226, 1246 configured to perform the stated processes/algorithm, stored within a computer-readable medium for implementation by the one or more processors 1206, 1226, 1246, or a combination thereof.

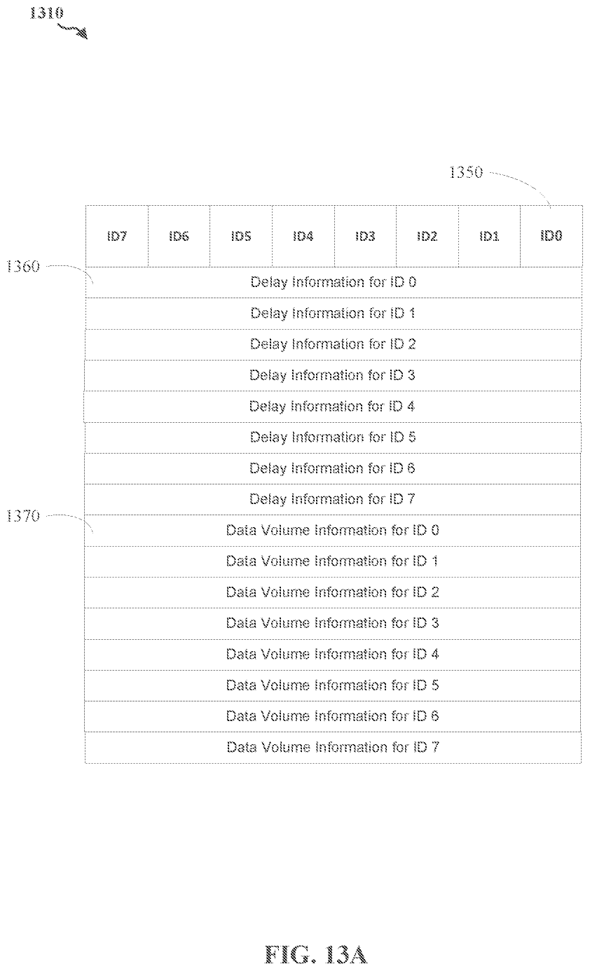

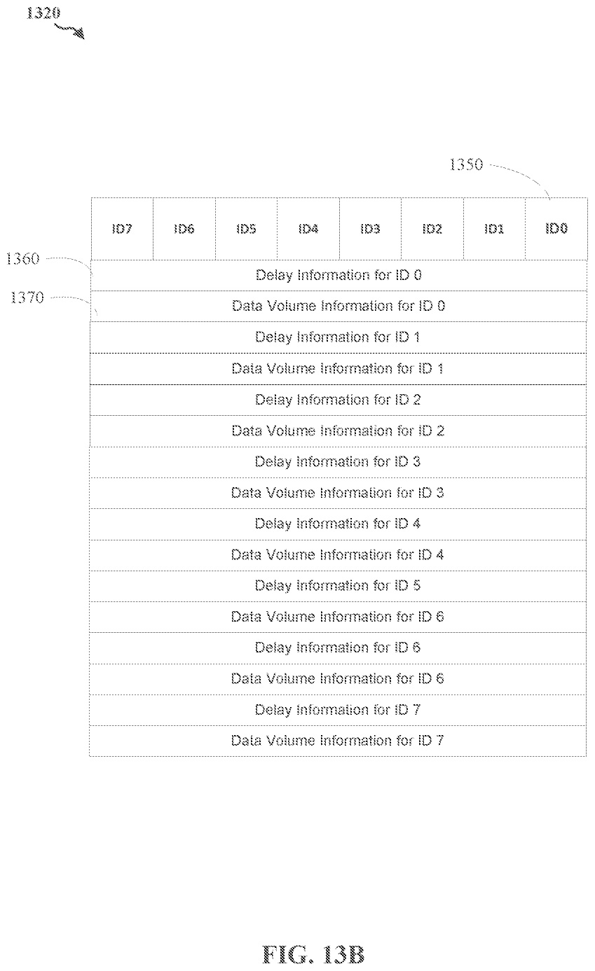

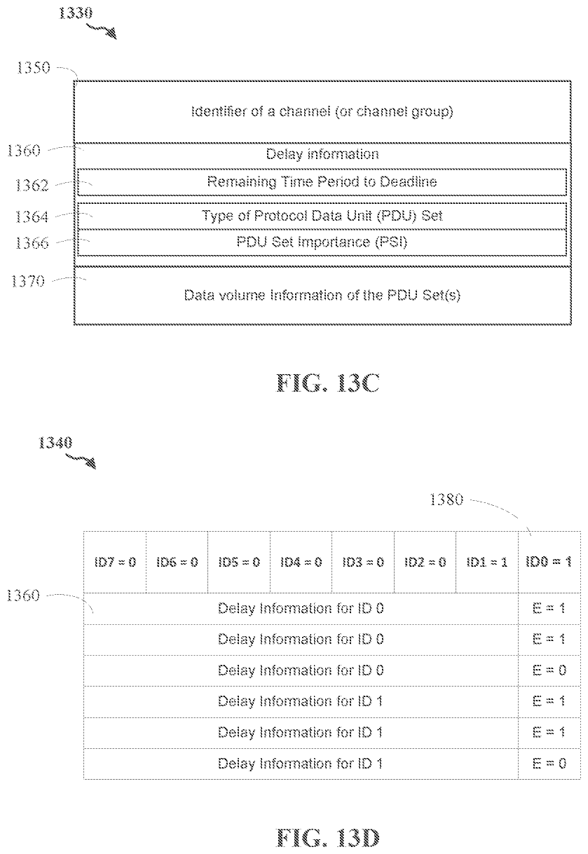

FIG. 13A is an example 1310 of the second message that UE uses to transmit delay information (and data volume information). In the example 1310 shown, UE places the bitmap at the beginning of the second message. ID0 1350 is a bit map to a channel (or channel group) and ID1 is mapped to another channel (or channel group). After the bitmap, UE places delay information field 1360 of channels (or channel groups) in the same order as the bit map to the channel (or channel group). UE places data volume information 1370 after all delay information in the same order as the corresponding bit order in the bitmap. In another embodiment, UE places all delay information 1360 after all data volume information 1370.

In the example 1320 shown in FIG. 13B, UE places data volume information 1370 of a channel (or channel group) immediately after the delay information 1360 of the channel (or channel group).

In the example 1330 shown in FIG. 13C, the message includes an identifier field 1350. UE sets the identifier field to the identifier of a channel (or channel group) and UE places delay information 1360 immediately after the identifier field. UE places the data volume information 1370 after the delay information.

FIG. 13D illustrates an example 1340 that each delay information field 1360 is associated with an extension field 1380. If extension field is 0, the corresponding delay information is the last one for the channel (or channel group).

Referring to FIGS. 13A-13D, the delay information includes the remaining time period to a deadline for PDU sets, types of PDU sets, and/or the PDU set importance (PSI) information, for prioritizing the delay information. For example, as shown in FIG. 13C, the delay information 1360 includes the remaining time period to the deadline 1362, the type of PDU set 1364, and PSI 1366. The data volume information 1370 includes information of PDU set(s) buffered for transmission.

A network entity may use PSI for discarding PDU sets packets in the presence of network congestion. For example, a network entity may indicate a PSI threshold to the UE. The UE may compare the PSI to the threshold to determine whether or when to discard or transmit the PDU set(s), or determine the time period needed for transmitting the PDU set(s).

The following table illustrates an example of the value of delay information. UE sets the delay information field to be an indicator that is associated with a time range that the remaining time (or queueing delay) falls in.

| Indicator | Range | |
|---|---|---|
| 0 | 0~10 | ms |
| 1 | 11~15 | ms |
| 2 | 16~20 | ms |
| 3 | 21 <= 25 | ms |
| 4 | 26 <= 30 | ms |
| 5 | 31 <= 35 | ms |

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112 (f), for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

### EXAMPLES

Example 1. A method, performed by a user equipment (UE) in a wireless communication system, the method comprising:
receiving a first message configuring UE with one or more channels and associated parameters;
determining delay information in accordance to a reference time;
determining delay information to transmit in accordance to one or more thresholds;
   transmitting a second message containing delay information (and data volume information).

Example 2. The method of Example 1, wherein the first message comprises at least one of:
a. A delay budget of a channel (channel group);
b. An offset to a reference time;
c. Max number of delay information to transmit for a channel (or channel group);
d. A first threshold to select which delay information to transmit; or
e. A second threshold to select which delay information to transmit.

Example 3. The method of Example 1, further comprising: using the time that UE is scheduled to transmit delay information as reference time to determine the delay information.

Example 4. The method of Example 3, further comprising: using the time that UE transmits the delay information or repeats the transmission of delay information as the reference time to determine the delay information.

Example 5. The method of Example 1, further comprising: using the time that UE receives an uplink grant to transmit delay information as the reference time to determine the delay information.

Example 6. The method of Example 4, wherein the remaining time of delay information is (data arrival time+delay budget−reference time).

Example 7. The method of Example 4, wherein the queueing delay is (reference time-data arrival time).

Example 8. The method of Example 1, further comprising, adjusting the reference time by an offset included in the first message.

Example 9. The method of Example 1, further comprising, selecting the remaining time to transmit if the remaining time of delay information is smaller than or equal to the first threshold.

Example 10. The method of Example 9, wherein the first threshold is a predefined value.

Example 11. The method of Example 9, wherein the BS includes the first threshold in the first message.

1Example 2. The method of Example 1, further comprising, selecting the remaining time to transmit if the remaining time of delay information is larger than or equal to the second threshold.

Example 13. The method of Example 12, wherein the second threshold is a predefined value.

Example 14. The method of Example 13, wherein the BS includes the second threshold in the first message.

Example 15. The method of Example 13, wherein the second threshold is the time between that UE transmits the delay information of data and that UE transmits the data of the delay information after UE receives an uplink grant.

Example 16. The method of Example 1, wherein UE includes data volume information in the second message.

Example 17. The method of Example 16, wherein the data volume information for a PDU set is the sum of sizes of data in the PDU set, whose delay information is selected to transmit.

Example 18. The method of Example 16, wherein the data volume information for a channel is the sum of sizes of data in the channel, whose delay information is selected to transmit.

Example 19. The method of Example 18, wherein the data volume information for a channel group is the sum of sizes of data in the channel group, whose remaining time is selected to transmit.

Example 20. The method of Example 1, wherein the second message comprises at least one field of:
a. A bit field that is associated with a channel or a channel group;
b. An identifier field that is set to the identifier of a channel or channel group;
c. A remaining time field that is associated with the bit field or identifier field;
d. A queueing delay field that is associated with the bit field or identifier field;
e. An extension field that is associated with a remaining time field or queueing delay field;
f. A data volume field, that is associated with a remaining time field or a queueing delay field;
g. A data volume field, that is associated with a bit field or an identifier field.

Example 21. The method of Example 20, wherein the remaining time field is set to the value of a remaining time.

Example 22. The method of Example 20, wherein the remaining time field is set to an indicator associated with a range of time that the remaining time fall in.

Example 23. A method, performed by a base station (BS) in a wireless communication system, the method comprising:
Transmitting a first message to UE;
Transmitting an uplink grant to UE;
Receiving a second message including delay information (and data volume information);
Determining deadline of data from the delay information (and data volume information);
Transmit an uplink grant to UE.

Example 24. The method of Example 23, wherein the first message configuring the UE comprises at least one of:
a radio resource control (RRC) reconfiguration message;
an RRC setup message;
an RRC re-establishment message;
an RRC resume message;
a system information message.

Example 25. The method of Example 24, wherein BS transmits the uplink grant in at least one of:
a downlink control information (DCI);
a random access response (RAR) message;
an RRCReconfiguraiton message;
an RRCRelease message.

Example 26. The method of Example 24, further comprising, use the reference time to determine deadline of data.

Example 27. The method of Example 26, wherein deadline is (reference time+remaining delay).

Example 28. The method of Example 26, wherein the deadline of data is (reference time+delay budget−queueing delay).

Example 29. The method of Example 23, further comprising, transmitting an uplink grant to UE, wherein the uplink grant allows UE to transmit the amount of data that UE reports in data volume information.

Example 30. A method of wireless communications by a user equipment, UE, the method comprising:
estimating, during communications with a network entity, a time period for completing a transmission of an amount of data in a buffer of the UE to the network entity;
ascertaining a delivery deadline based on the time period and a reference time agreed upon between the UE and the network entity;
identifying, based on the delivery deadline, delay information associated with the amount of data in the buffer; and
transmitting the delay information to the network entity in response to an uplink grant received from the network entity.

Example 31. The method of Example 30, wherein the delay information comprises, for each data packet in the amount of data, a remaining time period to a delivery deadline.

Example 32. The method of Example 30 or 31, wherein the amount of data comprises one or more data packets and the delay information comprises one or more corresponding instances of respective remaining time periods.

Example 33. The method of Example 32, wherein the one or more data packets share one corresponding remaining time period.

Example 34. The method of any of Examples 30 to 33, further comprising:
receiving, for the communications with the network entity, a configuration that indicates one or more channels and associated parameters from the network entity.

Example 35. The method of Example 34, wherein the configuration comprises at least one of:
a channel or a channel group;
a delay budget of the channel or the channel group;
an offset to the reference time;
an upper limit of instances of delay information to transmit for each channel or channel group;
a first timing threshold to select one of a plurality of instances of the delay information to transmit; or
a second timing threshold to select one of the plurality of instances of the delay information to transmit.

Example 36. The method of Example 34 or 35, wherein the reference time corresponds to a time when the UE receives the uplink grant from the network entity.

Example 37. The method of Example 36, wherein the reference time comprises an offset time corresponding to a roundtrip propagation delay between the UE and the network entity.

Example 38. The method of Example 34, further comprising:
receiving the uplink grant from the network entity, wherein the reference time corresponds to a time when the UE transmits an uplink transmission according to the uplink grant.

Example 39. The method of Example 38, wherein the uplink grant comprises a configured grant or a dynamic grant.

Example 40. The method of any of Examples 35 to 39, wherein the remaining time period comprises a sum of an arrival time of a corresponding data packet and a delay budget subtracted by the reference time, the arrival time corresponding to when the corresponding data packet enters a protocol layer buffer.

Example 41. The method of any of Examples 35 to 39, wherein the delay information further comprises a queueing delay being equal to a difference between the reference time and the arrival time.

Example 42. The method of any of Examples 32 to 41, wherein transmitting the delay information comprises:
selecting, among a plurality of remaining time periods of corresponding data packets in the amount of data, one or more of the plurality of remaining time periods not exceeding a first threshold to be included in the delay information.

Example 43. The method of Example 42, wherein the first threshold is predefined or included in the configuration, and wherein the first threshold corresponds to whether the UE is capable of completing transmission of the corresponding data packets, such that the corresponding data packets are to be transmitted to the network entity after the one or more of the plurality of remaining time periods are reported to the network entity.

Example 44. The method of Example 42, wherein transmitting the delay information further comprises:
selecting, among the plurality of remaining time periods of corresponding data packets in the amount of data, one or more of the plurality of remaining time periods greater than or equal to a second threshold.

Example 45. The method of Example 44, wherein the second threshold is predefined or included in the configuration, and wherein the second threshold corresponds to a lower limit of a time duration between transmitting the delay information and transmitting the corresponding data packets according to the uplink grant, such that data packets associated with remaining time periods under the lower limit are not transmitted.

Example 46. The method of any of Examples 30-45, wherein transmitting the delay information comprises:
including, in the delay information, data volume information of corresponding data packets.

Example 47. The method of Example 46, wherein the data volume information includes at least one of:
a first sum of sizes of the corresponding data packets in a protocol data unit, PDU, set;
a second sum of sizes of the corresponding data packets in a channel; or
a third sum of sizes of the corresponding data packets in a channel group.

Example 48. The method of Example 47, wherein transmitting the delay information further comprises:
sending the delay information in a message having a plurality of fields including one or more of:
   a bit field associated with the channel or the channel group;
   an identifier field set to the identifier of the channel or the channel group;
   a remaining time field associated with the bit field or identifier field;
   a queueing delay field associated with the bit field or identifier field;
   delay field; an extension field associated with a remaining time field or queueing
   a data volume field, that is associated with a remaining time field or a queueing delay field; and
   a data volume field associated with a bit field or an identifier field.

Example 49. The method of Example 48, wherein the remaining time field presents values indicating at least one of:
one or more remaining time periods of respective data packets to be transmitted; or
a range of time period including the one or more remaining time periods of respective data packets to be transmitted.

Example 50. A method of wireless communications by a network entity, the method comprising:
transmitting, to a user equipment, UE, a configuration that indicates one or more channels and associated parameters for an uplink transmission;
receiving delay information from the UE regarding the uplink transmission, the delay information associated with a time period for completing a transmission of an amount of data in a buffer of the UE; and
transmitting, to the UE, an uplink grant (the updated 614) based on the delay information and a delivery deadline computed using the time period and a reference time agreed upon between the UE and the network entity.

Example 51. The method of Example 50, wherein the delay information comprises, for each data packet in the amount of data, a remaining time period to a delivery deadline.

Example 52. The method of Example 50 or 51, wherein the amount of data comprises one or more data packets and the delay information comprises one or more corresponding instances of respective remaining time periods.

Example 53. The method of Example 52, wherein the one or more data packets share one corresponding remaining time period.

Example 54. The method of any of Examples 50 to 53, further comprising:
transmitting, for the communications with the UE, a configuration that indicates one or more channels and associated parameters to the UE.

Example 55. The method of Example 54, wherein the configuration comprises at least one of:
a channel or a channel group;
a delay budget of the channel or the channel group;
an offset to the reference time;
an upper limit of instances of delay information to transmit for each channel or channel group;
a first timing threshold to select one of a plurality of instances of the delay information to transmit; or
a second timing threshold to select one of the plurality of instances of the delay information to transmit.

Example 56. The method of Example 54 or 55, wherein the reference time corresponds to a time when the network entity transmits the uplink grant to the UE.

Example 57. The method of Example 56, wherein the reference time comprises an offset time corresponding to a roundtrip propagation delay between the UE and the network entity.

Example 58. The method of Example 54, further comprising:
transmitting the uplink grant from the network entity, wherein the reference time corresponds to a time when the UE transmits an uplink transmission according to the uplink grant.

Example 59. The method of Example 58, wherein the uplink grant comprises a configured grant or a dynamic grant.

Example 60. The method of any of Examples 55 to 59, wherein the remaining time period comprises a sum of an arrival time of a corresponding data packet and a delay budget subtracted by the reference time, the arrival time corresponding to when the corresponding data packet enters a protocol layer buffer.

Example 61. The method of any of Examples 55 to 59, wherein the delay information further comprises a queueing delay being equal to a difference between the reference time and the arrival time.

Example 62. The method of any of Examples 50-61, wherein receiving the delay information comprises:
obtaining, in the delay information, data volume information of corresponding data packets.

Example 63. The method of Example 62, wherein the data volume information includes at least one of:
a first sum of sizes of the corresponding data packets in a protocol data unit, PDU, set;
a second sum of sizes of the corresponding data packets in a channel; or
a third sum of sizes of the corresponding data packets in a channel group.

Example 64. The method of Example 63, wherein receiving the delay information further comprises:
obtaining the delay information in a message having a plurality of fields including one or more of:
   a bit field associated with the channel or the channel group;
   an identifier field set to the identifier of the channel or the channel group;
   a remaining time field associated with the bit field or identifier field;
   a queueing delay field associated with the bit field or identifier field;
   an extension field associated with a remaining time field or queueing delay field;
   a data volume field, that is associated with a remaining time field or a queueing delay field; and
   a data volume field associated with a bit field or an identifier field.

Example 65. The method of Example 64, wherein the remaining time field presents values indicating at least one of:
one or more remaining time periods of respective data packets to be transmitted; or
a range of time period including the one or more remaining time periods of respective data packets to be transmitted.

Example 66. An apparatus for wireless communication comprising a transceiver and a processor coupled to the transceiver and configured to implement a method as in any of Examples 30-65.

Example 67. A method of wireless communications by a user equipment, UE, the method comprising:
receiving an uplink grant from a network entity; and
transmitting, to the network entity in response to the uplink grant, delay information associated with an amount of data having a delivery deadline in a buffer of the UE, the delay information identified based on the delivery deadline and a reference time agreed between the UE and the network entity.

Example 68. The method of Example 67, wherein the delay information comprises, for each data packet in the amount of data, a remaining time period to the delivery deadline for each data packet.

Example 69. The method of Example 67 or 68, wherein the amount of data comprises one or more data packets and the delay information comprises one or more corresponding instances of respective remaining time periods.

Example 70. The method of any of Examples 67 to 69, wherein:
the amount of data comprises a first amount of data in a protocol data unit (PDU) set; and
the delay information further comprises an indicator for a type of the PDU set.

Example 71. The method of Example 70, wherein the delay information further comprises a PDU set importance (PSI) for the type of the PDU set.

Example 72. The method of any of Examples 67 to 71, wherein the one or more data packets share one corresponding remaining time period.

Example 73. The method of any of Examples 67 to 72, further comprising:
receiving, for the communications with the network entity, a configuration that indicates one or more channels and associated parameters from the network entity.

Example 74. The method of Example 73, wherein the configuration comprises at least one of:
a channel or a channel group;
a delay budget of the channel or the channel group;
an offset to the reference time;
an upper limit of instances of delay information to transmit for each channel or channel group;
a first timing threshold to select one of a plurality of instances of the delay information to transmit; or
a second timing threshold to select one of the plurality of instances of the delay information to transmit.

Example 75. The method of Example 73 or 74, wherein the reference time corresponds to a time when the UE receives the uplink grant from the network entity.

Example 76. The method of Example 75, wherein the reference time comprises an offset time corresponding to a roundtrip propagation delay between the UE and the network entity.

Example 77. The method of Example 73, further comprising:
receiving the uplink grant from the network entity, wherein the reference time corresponds to a time when the UE transmits an uplink transmission according to the uplink grant.

Example 78. The method of Example 77, wherein the uplink grant comprises a configured grant or a dynamic grant.

Example 79. The method of any of Examples 74 to 78, wherein the remaining time period comprises a sum of an arrival time of a corresponding data packet into a protocol layer buffer and a delay budget subtracted by the reference time.

Example 80. The method of any of Examples 79, wherein the delay information further comprises a queueing delay being equal to a difference between the reference time and the arrival time.

Example 81. The method of any of Examples 71 to 80, wherein transmitting the delay information comprises:
selecting, among a plurality of remaining time periods of corresponding data packets in the amount of data, one or more of the plurality of remaining time periods not exceeding a first threshold to be included in the delay information.

Example 82. The method of Example 81, wherein the first threshold is predefined or included in the configuration, and wherein the first threshold corresponds to whether the UE is capable of completing transmission of the corresponding data packets prior to the delivery deadline and after the transmitting the delay information.

Example 83. The method of Example 81, wherein transmitting the delay information further comprises:
selecting, among the plurality of remaining time periods of corresponding data packets in the amount of data, one or more of the plurality of remaining time periods greater than or equal to a second threshold.

Example 84. The method of Example 83, wherein the second threshold is predefined or included in the configuration, and wherein the second threshold corresponds to a lower limit of a time duration between transmitting the delay information and transmitting the corresponding data packets according to the uplink grant, such that data packets associated with remaining time periods under the lower limit are not transmitted.

Example 85. The method of any of Examples 67 to 84, wherein transmitting the delay information comprises:
including, in the delay information, data volume information of corresponding data packets.

Example 86. The method of Example 85, wherein the data volume information includes at least one of:
a first sum of sizes of the corresponding data packets in a protocol data unit, PDU, set;
a second sum of sizes of the corresponding data packets in a channel; or a third sum of sizes of the corresponding data packets in a channel group.

Example 87. The method of Example 86, wherein transmitting the delay information further comprises:
sending the delay information in a message having a plurality of fields including one or more of:
   a bit field associated with the channel or the channel group;
   an identifier field set to the identifier of the channel or the channel group;
   a remaining time field associated with the bit field or identifier field;
   a queueing delay field associated with the bit field or identifier field;
   delay field; an extension field associated with a remaining time field or queueing
   a data volume field, that is associated with a remaining time field or a queueing delay field; and
   a data volume field associated with a bit field or an identifier field.

Example 88. The method of Example 87, wherein the remaining time field presents values indicating at least one of:
one or more remaining time periods of respective data packets to be transmitted; or
a range of time period including the one or more remaining time periods of respective data packets to be transmitted.

Example 89. A method of wireless communications by a network entity, the method comprising:
transmitting, to a user equipment, UE, a configuration indicating one or more channels and associated parameters for an uplink transmission;
receiving delay information from the UE regarding the uplink transmission, the delay information associated with a time period for completing a transmission of an amount of data in a buffer of the UE; and
transmitting, to the UE, an uplink grant (614) based on the delay information and a delivery deadline computed using the time period and a reference time agreed upon between the UE and the network entity.

Example 90. The method of Example 89, wherein the delay information comprises, for each data packet in the amount of data, a remaining time period to a delivery deadline.

Example 91. The method of Example 89 or 90, wherein the amount of data comprises one or more data packets and the delay information comprises one or more corresponding instances of respective remaining time periods.

Example 92. The method of any of Examples 89 to 91, wherein:
the amount of data comprises a first amount of data in a protocol data unit (PDU) set; and
the delay information further comprises an indicator for a type of the PDU set.

Example 93. The method of Example 92, wherein the delay information further comprises a PDU set importance (PSI) for the type of the PDU set.

Example 94. The method of Example 93, wherein the one or more data packets share one corresponding remaining time period.

Example 95. The method of any of Examples 91 to 94, wherein the configuration comprises at least one of:
a channel or a channel group;
a delay budget of the channel or the channel group;
an offset to the reference time;
an upper limit of instances of delay information to transmit for each channel or channel group;
a first timing threshold to select one of a plurality of instances of the delay information to transmit; or
a second timing threshold to select one of the plurality of instances of the delay information to transmit.

Example 96. The method of Example 95, wherein the reference time corresponds to a time when the network entity transmits the uplink grant to the UE.

Example 97. The method of Example 96, wherein the reference time comprises an offset time corresponding to a roundtrip propagation delay between the UE and the network entity.

Example 98. The method of Example 95, further comprising:
transmitting the uplink grant from the network entity, wherein the reference time corresponds to a time when the UE transmits an uplink transmission according to the uplink grant.

Example 99. The method of Example 98, wherein the uplink grant comprises a configured grant or a dynamic grant.

Example 100. The method of any of Examples 96 to 99, wherein the remaining time period comprises a sum of an arrival time of a corresponding data packet and a delay budget subtracted by the reference time, the arrival time corresponding to when the corresponding data packet enters a protocol layer buffer.

Example 101. The method of Example 100, wherein the delay information further comprises a queueing delay being equal to a difference between the reference time and the arrival time.

Example 102. The method of any of Examples 89-99, wherein receiving the delay information comprises:
obtaining, in the delay information, data volume information of corresponding data packets.

Example 103. The method of Example 102, wherein the data volume information includes at least one of:
a first sum of sizes of the corresponding data packets in a protocol data unit, PDU, set;
a second sum of sizes of the corresponding data packets in a channel; or
a third sum of sizes of the corresponding data packets in a channel group.

Example 104. The method of Example 103, wherein receiving the delay information further comprises:
obtaining the delay information in a message having a plurality of fields including one or more of:
   a bit field associated with the channel or the channel group;
   an identifier field set to the identifier of the channel or the channel group;
   a remaining time field associated with the bit field or identifier field;
   a queueing delay field associated with the bit field or identifier field;
   an extension field associated with a remaining time field or queueing delay field;
   a data volume field, that is associated with a remaining time field or a queueing delay field; and
   a data volume field associated with a bit field or an identifier field.

Example 105. The method of Example 104, wherein the remaining time field presents values indicating at least one of:
one or more remaining time periods of respective data packets to be transmitted; or
a range of time period including the one or more remaining time periods of respective data packets to be transmitted.

Example 106. An apparatus for wireless communication comprising a transceiver and a processor coupled to the transceiver and configured to implement a method as in any of Examples 67-105.

What is claimed is:

1-15. (canceled)

16. A method of wireless communications by a user equipment (UE), the method comprising:
receiving an uplink grant from a network entity; and
transmitting, to the network entity in response to the uplink grant, delay information including a remaining time associated with an amount of data having a delivery deadline in a buffer of the UE, the remaining time being a remaining time to the delivery deadline of the data.

17. The method of claim 16, wherein the delay information comprises a shortest remaining time among a plurality of remaining times for a channel group selected for transmission to the network entity.

18. The method of claim 16, wherein the amount of data comprises one or more data packets and the delay information comprises one or more corresponding instances of respective remaining time periods.

19. The method of claim 18, wherein the one or more data packets share one corresponding remaining time period.

20. The method of claim 16, wherein:
the amount of data comprises a first amount of data in a protocol data unit (PDU) set; and
the delay information further comprises an indicator for a type of the PDU set.

21. The method of claim 20, wherein the delay information further comprises a PDU set importance (PSI), for the type of the PDU set.

22. The method of claim 16, further comprising:
receiving, for the communications with the network entity, a configuration that indicates one or more channels and associated parameters from the network entity, wherein the configuration comprises at least one of:
a channel or a channel group;
a delay budget of the channel or the channel group;
an offset to a reference time for computing the delivery deadline;
an upper limit of instances of delay information to transmit for each channel or channel group;
a first timing threshold to select one of a plurality of instances of the delay information to transmit; or
a second timing threshold to select one of the plurality of instances of the delay information to transmit.

23. The method of claim 22, wherein transmitting the delay information comprises:
selecting, among a plurality of remaining time periods of corresponding data packets in the amount of data, one or more of the plurality of remaining time periods not exceeding a first threshold to be included in the delay information.

24. The method of claim 23, wherein the first threshold is predefined or included in the configuration, and wherein the first threshold corresponds to whether the UE is capable of completing transmission of the corresponding data packets prior to the delivery deadline and after the transmitting the delay information.

25. The method of claim 24, wherein transmitting the delay information further comprises:
selecting, among the plurality of remaining time periods of corresponding data packets in the amount of data, one or more of the plurality of remaining time periods greater than or equal to a second threshold.

26. The method of claim 25, wherein the second threshold is predefined or included in the configuration, and wherein the second threshold corresponds to a lower limit of a time duration between transmitting the delay information and transmitting the corresponding data packets according to the uplink grant, such that data packets associated with remaining time periods under the lower limit are not transmitted.

27. The method of claim 1, wherein transmitting the delay information comprises:
including, in the delay information, data volume information of corresponding data packets.

28. A method of wireless communications by a network entity, the method comprising:
transmitting, to a user equipment (UE), a configuration indicating one or more channels and associated parameters for an uplink transmission;
receiving delay information from the UE regarding the uplink transmission, the delay information associated with a remaining time associated with an amount of data having a delivery deadline in a buffer of the UE, the remaining time being a remaining time to the delivery deadline of the data; and
transmitting, to the UE, an uplink grant based on the delay information and the delivery deadline for the transmission of the amount of data in the buffer of the UE.

29. The method of claim 28, wherein the delay information comprises a shortest remaining time among a plurality of remaining times for a channel group selected for transmission to the network entity.

30. An apparatus for wireless communication comprising:
a transceiver; and
a processor coupled to the transceiver, the processor configured to:
receive an uplink grant from a network entity; and
transmit, to the network entity in response to the uplink grant, delay information including a remaining time associated with an amount of data having a delivery deadline in a buffer of the apparatus, the remaining time being a remaining time to the delivery deadline of the data.

31. The apparatus of claim 30, wherein the delay information comprises a shortest remaining time among a plurality of remaining times for a channel group selected for transmission to the network entity.

32. The apparatus of claim 30, wherein the amount of data comprises one or more data packets and the delay information comprises one or more corresponding instances of respective remaining time periods.

33. The apparatus of claim 32, wherein the one or more data packets share one corresponding remaining time period.

34. The apparatus of claim 30, wherein:
the amount of data comprises a first amount of data in a protocol data unit (PDU) set; and
the delay information further comprises an indicator for a type of the PDU set.

35. The apparatus of claim 34, wherein the delay information further comprises a PDU set importance (PSI), for the type of the PDU set.
